(19) United States
(12) Patent Application Publication
(10) Pub. No.: US 2013/0278905 A1
(43) Pub. Date: Oct. 24, 2013

(54) COOLING MODEL STRUCTURE

(71) Applicants: Tze-Yun Sung, Taipei (TW); Chih-Der Chuan, Taipei (TW)

(72) Inventors: Tze-Yun Sung, Taipei (TW); Chih-Der Chuan, Taipei (TW)

(73) Assignee: Ko, Chi-Yuan of Cordic Technology Co., Ltd.

(21) Appl. No.: 13/455,109

(22) Filed: Apr. 24, 2012

(51) Int. Cl. G03B 21/16

(52) U.S. Cl. CPC G03B 21/16
USPC 353/57

(57) ABSTRACT

In priority art, the projector emits light through lens and other optical devices to display devices for projecting images. Such devices produce a lot of heat. Present cooling model structure must use over 2 fans to reduce the working temperature of the projector and keep the projector functional. However, it cause increasing of electricity consuming and the price of production.

The invention use only one fan and exhaust the heat by the combination of heat conductive nugget (33) and heat conductive object (32) for reducing working temperature and keep the projector functional.

### FIELD OF THE INVENTION

The present invention relates to a cooling model for exhausting heat which is produced by light emitting device, lens and optics devices of projector.

### BACKGROUND OF INVENTION

The projecting technology has become well developed gradually. The projector also has been used widely. For example, briefing in meeting, travelling exhibition, promotion activities, teaching at school, academic conference and home cinema . . . etc.

In priority art, the projector emits light through lens and other optical devices to display devices for projecting images. Such devices produce a lot of heat, if the heat could not exhaust effectively, the projector would jam or the devices in the projector would be burned, cause repairment or even discard. Thus present cooling model structure must use over 2 fans to reduce the working temperature of the projector and keep the projector functional. However, it cause increasing of electricity consuming and price of production.

The purpose of the invention is to reduce the working temperature of the projector and keep the projector functional only with one fan.

### SUMMARY OF THE INVENTION

For achieving the object, the method is as following: the projector includes: an optical engine model, a projecting model which is disposed on aside of said optical engine model, a lens model which react with optical engine model which is disposed at aside of it, and a cooling model inside the projector which is for radiating. The cooling model is among optical engine model, projecting model and lens model, which includes a fan among the 3 models said above, a heat conductive object which is disposed aside of the fan and a heat conductive nugget which is disposed at aside of said heat conductive object which could react with and absorb the heat form optical engine model.

Moreover, the heat conductive object is assembled by a elongate conduit and a heat sink which is disposed on one termination of the conduit which is face to the said fan. The said heatsink is one of following utility: the U-shape heatsink, the O shape heatsink and the straight heatsink.

Moreover, one side of said heat conductive nugget has a gutter for restoring the said conduit.

Moreover, The said fan is under the projecting device which is among optical engine model, lens model and cooling model.

Moreover, the first wiring board is above the fan which is covering on the said optical engine model.

Moreover, the second first wiring board is above the projecting model.

This invention could conduct cool air into the project by one fan, and reduce the working temperature inside the projector. The principle is to inhale the cool air upward by fan, and make a circle inside the projecting device than spread out. The heat which is produced by optical engine model, projecting model and lens model would be taken away quickly.

Comparing with prior art, the invention could reduce the working temperature of projector quickly and improve the condition of system operating effectively.

### BRIEF DESCRIPTION OF THE DRAWINGS

FIG. 1 is the illusion of depth of the embodiment.

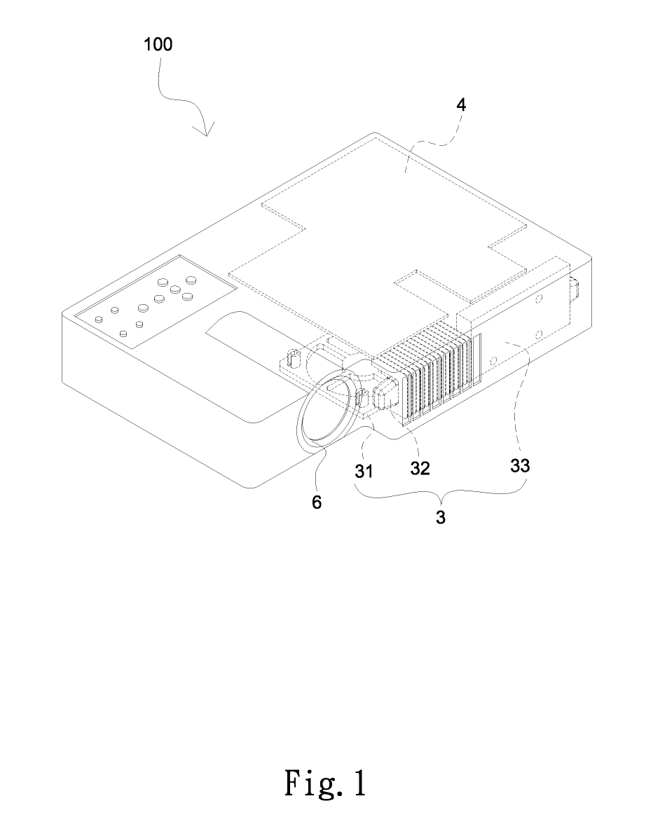

FIG. 2 is the top view of the embodiment.

FIG. 3 is the scheme of practicing of the embodiment.

FIG. 4 is the scheme of the combination between the heat conductive object and the heat conductive nugget.

FIG. 5 is the scheme of every type of the conductive nugget.

### DETAILED DESCRIPTION OF PREFERRED EMBODIMENTS

The detailed description with drawings is as below:

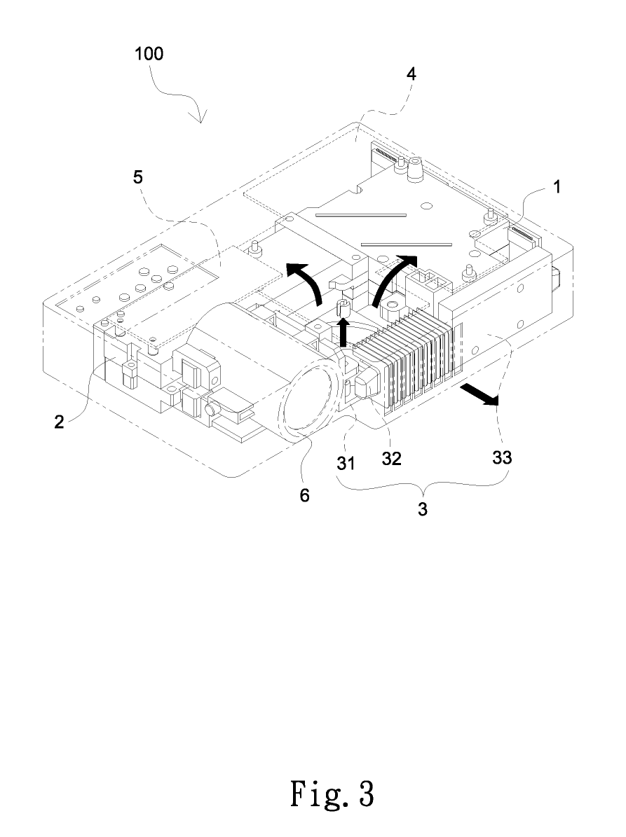

FIG. 3 reveals that the invention is a cooling model structure which used for a projector (100) which is assembled by an optical engine model (1), a projecting model (2) which is at aside of said optical engine model (1), and a cooling model (3) which is disposed between said optical engine model (1) and projecting model (2).

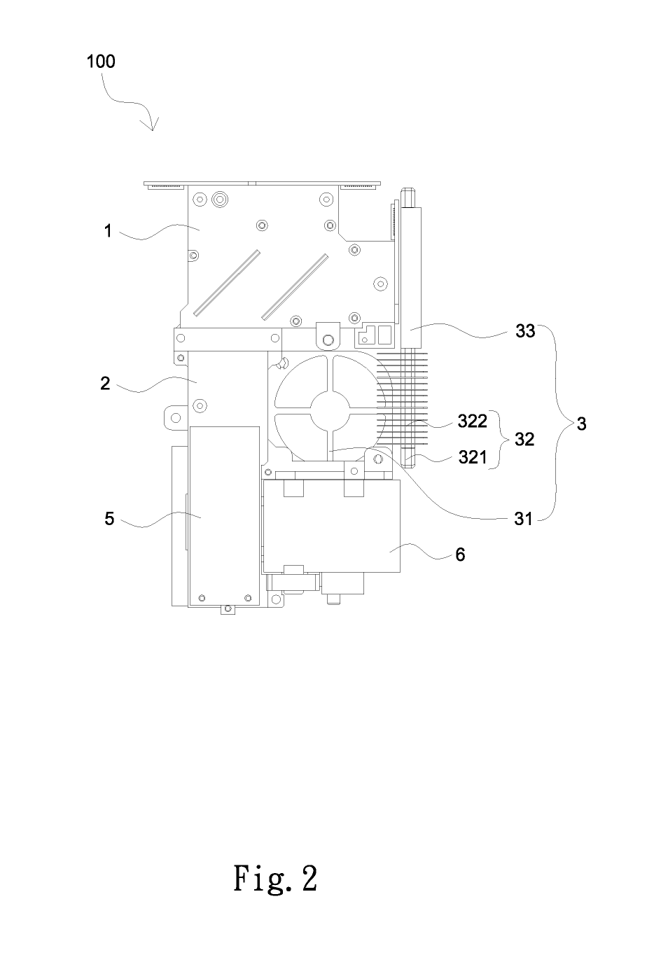

As FIG. 2 shown, the said cooling model (3) is assembled by a fan (31) which is disposed between the optical engine model (1) and projecting model (2), a heat conductive object (32) which is disposed at aside of said fan (31), and a heat conductive nugget (33) which is disposed at aside of said heat conductive object (32) which could react with and absorb the heat form the optical engine model (1).

The method of achieving the purpose is shown in FIG. 3:

First, the fan (31) inhales cold air form the air for increasing the flows which is on the way of curve lines of direction inside the projector (100) and reduce its working temperature.

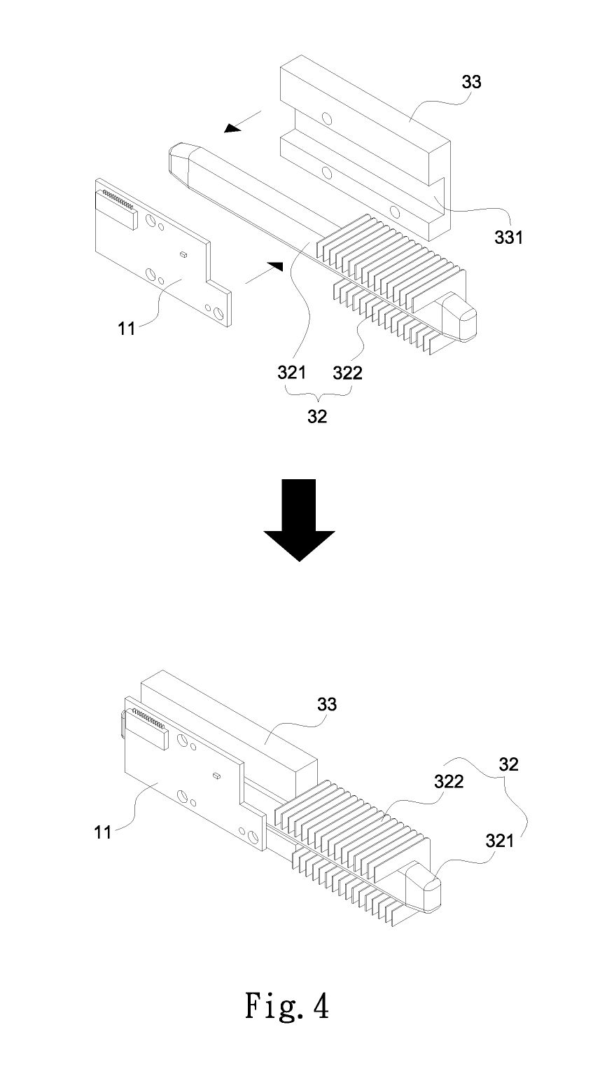

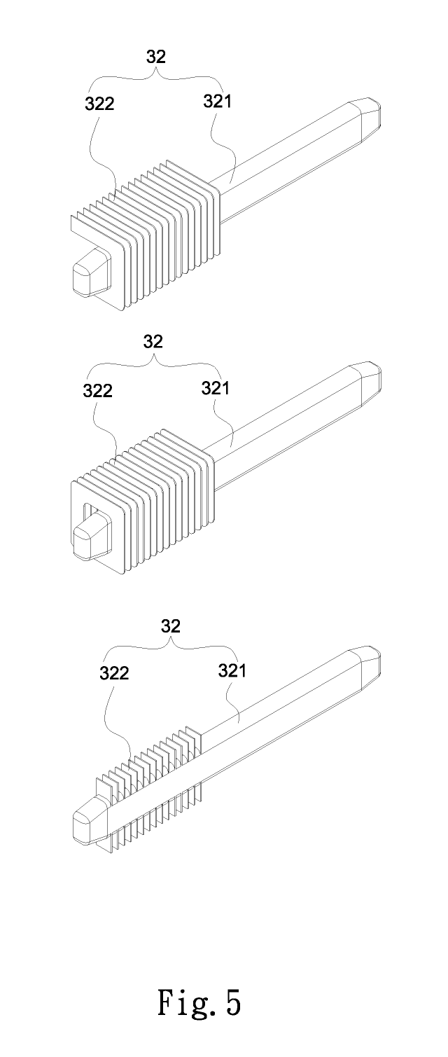

In FIG. 4, the heat conductive object (32) is assembled by a elongate conduit (321) and a heatsink (322) which is attached on the end of said elongate conduit (321). There is a gutter (331) on a side of the heat conductive nugget (33) for restoring another side of the conduit (321) which is a part of said heat conductive object (32). The side of said heat conductive nugget (33) with gutter is assembled with the side of the optical engine model (1) to sustain the side of elongate conduit (321) which is stored in the gutter (331) from losing or moving. And in FIG. 5, the said heatsink (322) is one of following utility: the U-shape heatsink, the O shape heatsink and the straight heatsink.

Than, the heat which is produced by the optical engine model (1) would be conducted through the heat conductive object (32) to the heat conductive nugget (32) and the heatsink (322) which is attached on the end of it by said gutter (331). Finally, the heat would be spread out on the way of straight line of direction by the flow which is brought by fan (3).

The said fan (31) is disposed under the projecting device with is among optical engine model (1), lens model (6) and cooling model (3) thus the air which is conducted by said fan (31) could flow upward and spread out to the direction without barrier and with low pressure.

The first wiring board (4) which is disposed above said fan (31) is covering the optical engine model (1). Therefore the heat on the first wiring board will be taken away at first by the upward air flow which is created by said fan (31) and the air flow will be conducted to become a circle inside the projector (100). Thus the working temperature would be reduced.

The second wiring board could be used to control the image which is projected by said projecting model (2). The heat which is produced by the second wiring board (5) and projecting model (2) would be taken away when the air flow is passing by.

Therefore, comparing with the prior art of cooling model structure, the new invention could exhaust the heat which produced by operating of projector away and keep the projector functional with only one fan, thus the electricity consuming and the price of production are reduced significantly.

What is claimed is:

1. A cooling model structure, which is adopt for the projector (100) includes an optical engine model (1); a projecting model (2) which is disposed on aside of said optical engine model (1); a lens model (6) which react with optical engine model (1) which is disposed at aside of it; a cooling model (3) inside the projector which is for radiating; the cooling model (3) is among said optical engine model (1), projecting model (2) and lens model (6), which includes a fan (31) among the 3 models said above, a heat conductive object (32) which is disposed aside of the fan (31) and a heat conductive nugget (33) which is disposed at aside of said heat conductive object (32) which could react with and absorb the heat form optical engine model (1).

2. A cooling model structure according to claim 1 wherein the said heat conductive object (32) is assembled by a elongate conduit (321) and a heatsink (322) which is disposed on one termination of said conduit (321) which is face to the said fan (31).

3. A cooling model structure according to claim 1 wherein the said heatsink (322) is one of following utility: the U-shape heatsink, the O shape heatsink and the straight heatsink.

4. A cooling model structure according to claim 1 wherein the said heat conductive nugget (33) has a gutter (331) on a side for restoring another side of the conduit (321) which is a part of said heat conductive object (32).

5. A cooling model structure according to claim 1 wherein the said fan (31) is under the projecting device (100) which is among optical engine model (1), lens model (6) and cooling mode (3).

6. A cooling model structure according to claim 1 wherein the first wiring board (4) is above the fan (31) which is covering on the said optical engine model (1).

7. A cooling model structure according to claim 1 wherein the second wiring board (5) is above the projecting model (2).
